(19) United States
(12) Patent Application Publication
(10) Pub. No.: US 2016/0091885 A1
(43) Pub. Date: Mar. 31, 2016

(54) MACHINING APPARATUS FOR MACHINING WORKPIECE WITH TOOL

(71) Applicants: DENSO CORPORATION, Kariya-city (JP); KYUSHU UNIVERSITY, NATIONAL UNIVERSITY CORPORATION, Fukuoka-shi (JP)

(72) Inventors: Kazutaka TOYODA, Kariya-shi (JP); Toshihiko KOYAMA, Anjo-shi (JP); Makoto HASHIZUME, Fukuoka (JP); Riichi OOUTIDA, Fukuoka (JP)

(21) Appl. No.: 14/867,093

(22) Filed: Sep. 28, 2015

(30) Foreign Application Priority Data
Sep. 29, 2014 (JP) 2014-198653

(51) Int. Cl. G05B 19/19

(52) U.S. Cl. CPC G05B 19/19; G05B 2219/45129; G05B 2219/37404

(57) ABSTRACT

In a machining apparatus, a tool has a specified point for machining a workpiece, and a support supports the tool while a position and an orientation of the specified point of the tool are changeable. A actuator actuates the support to move the tool, and a sensor measures a magnitude and an orientation of force upon the force being applied to the tool. A determiner determines, upon the force being applied to the tool, a target orientation of the specified point of the tool according to the magnitude and the orientation of the force measured by the sensor. The force applied to the tool having an orientation to separate the tool from the workpiece. A controller controls the actuator to move the tool according to the determined target orientation.

### CROSS REFERENCE TO RELATED APPLICATIONS

This application is based on and claims the benefit of priority from Japanese Patent Application 2014-198653 filed on Sep. 29, 2014, the disclosure of which is incorporated in its entirety herein by reference.

### TECHNICAL FIELD

The present disclosure relates to machining apparatuses for machining a workpiece with a tool.

### BACKGROUND

There is one known machining apparatus, which is disclosed in Japanese Patent Publication No. 5481919. The known machining apparatus moves a tool to abut on a workpiece, such as a hard workpiece, for machining the workpiece. At the abutment state, the known machining apparatus machines the workpiece with the tool while applying constant force to the tool to push the tool to the workpiece; the constant force is determined to overcome reaction force of the workpiece generated from the workpiece abutting on the tool.

### SUMMARY

Unfortunately, the known machining apparatus needs to be continuously applying the constant force to the tool after abutment of the tool onto the workpiece to machine the workpiece with the tool. The known machining apparatus may have therefore difficulty moving the tool away from the workpiece after abutment of the tool onto the workpiece to machine the workpiece with the tool in accordance with, for example, a user's intention. In other words, the known machining apparatus may have difficulty controlling movement of the tool different from the movement to push the tool onto the workpiece after abutment of the tool onto the workpiece to machine the workpiece with the tool.

One aspect of the present disclosure therefore seeks to provide machining apparatuses capable of addressing the problem set forth above.

Specifically, an alternative aspect of the present disclosure aims to provide such machining apparatuses, each of which is capable of controlling movement of the tool after abutment of the tool onto the workpiece to machine the workpiece with the tool, thus moving the tool away from the workpiece after abutment of the tool onto the workpiece.

According to an exemplary aspect of the present disclosure, there is provided a machining apparatus. The machining apparatus includes a tool, having a specified point, for machining a workpiece, and a support that supports the tool while a position and an orientation of the specified point of the tool are changeable. The machining apparatus includes an actuator that actuates the support to move the tool, and a sensor that measures a magnitude and an orientation of force upon the force being applied to the tool. The machining apparatus includes a determiner that determines, upon the force being applied to the tool, a target orientation of the specified point of the tool according to the magnitude of the force measured by the sensor. The force applied to the tool has an orientation to separate the tool from the workpiece. The machining machine includes a controller that controls the actuator to move the tool according to the determined target orientation.

The machining apparatus is configured to determine, upon the force, which has an orientation to separate the tool from the workpiece, being applied to the tool, the target orientation of the specified point of the tool according to the magnitude of the force measured by the sensor. This configuration enables proper determination of whether to move the tool in the orientation of the force applied to the tool or in another orientation different from the orientation according to the magnitude of the force applied to the tool. This therefore prevents the tool from being pushed onto the workpiece against a user's intention.

Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be construed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the structure of a machining apparatus according to an exemplary embodiment of the present disclosure;

FIG. 2 is a perspective view schematically illustrating an example of the structure of a tool movement device and an example of the structure of a target position detector included in the machining apparatus according to the exemplary embodiment;

FIG. 3 is a flowchart schematically illustrating an example of the procedure of a machining routine carried out by a controller illustrated in FIG. 1;

FIG. 4A is a view schematically illustrating force applied to a tool of the tool movement device illustrated in FIG. 1 by a user or an assistant;

FIG. 4B is a view schematically illustrating an example of a tool-based coordinate system defined in the tool;

FIG. 4C is a view schematically illustrating an example of a one-dimensional drilling coordinate system according to the exemplary embodiment of the present disclosure;

FIG. 5 is a timing chart schematically illustrating how the tool is moved relative to a workpiece under control of the controller illustrated in FIG. 1;

FIG. 6 is a block diagram schematically illustrating how the controller selects one of first to forth models according to force applied to the tool; and

FIGS. 7A and 7B are a joint graph including a graph schematically illustrating an example of how the measurement of a force sensor illustrated in FIG. 1 changes over time, and a graph schematically illustrating an example of how a working point of the tool moves in an axial direction of the tool.

### DETAILED DESCRIPTION OF EMBODIMENT

The following describes an exemplary embodiment of the present disclosure with reference to the accompanying drawings. The drawings utilize identical reference characters to identify identical corresponding components.

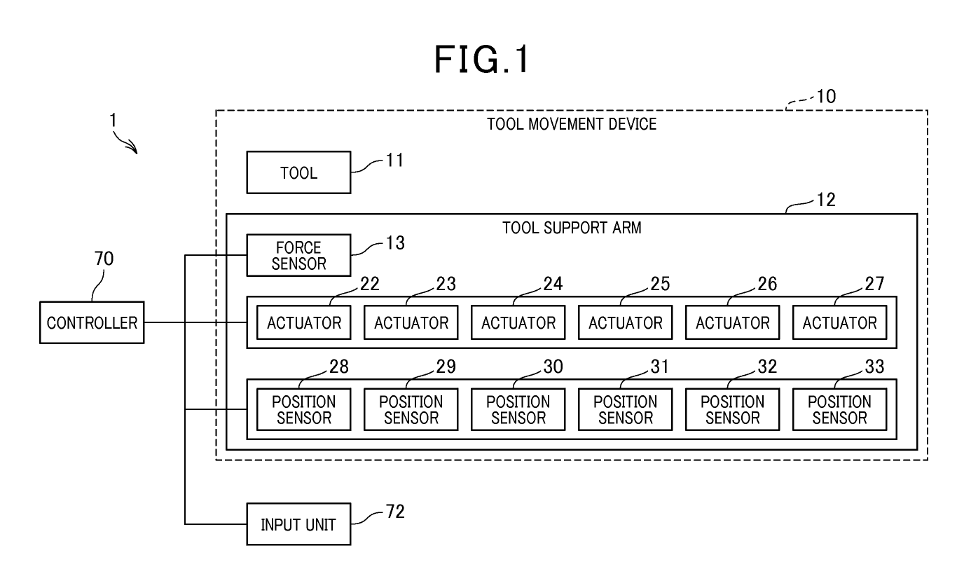

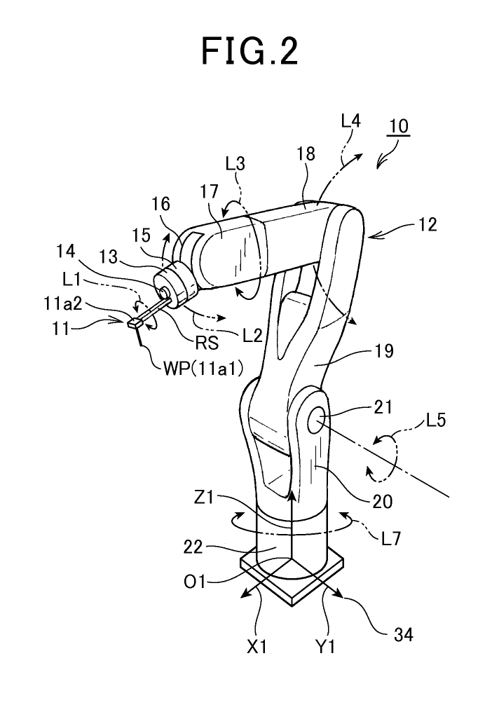

FIGS. 1 and 2 schematically illustrate a machining apparatus 1 according to the exemplary embodiment of the present disclosure. The machining apparatus 1 is used in the medical field, in particular, the dental field for locating a dental instrument to a predetermined position, such as the position of a missing tooth, in the mouth of a patient.

The machining apparatus 1 includes a tool movement device 10, a controller 70, and an input unit 72.

The tool movement device 10 includes a tool 11, a rod-like rigid support RS, and a support arm 12. The support arm 12 serves as, for example, a support. The tool 11 is a dental instrument including a drill having a substantially longitudinal cylindrical shape, a first end 11a1 for cutting away part of a jawbone and/or a tooth, and a second end 11a2 opposite to the first end 11a1 in its axial direction. The rod-like rigid support RS having a first end to which the second end 11a2 of the tool 11 is attached while the length direction of the tool 11 is substantially perpendicular to the rigid support RS. Hereinafter, the assembly of the tool 11 and the rigid support RS will also be referred to simply as a tool 11.

The tool support arm 12 is designed as a multijoint arm that provides multiple degrees of freedom to thereby movably support the tool 11 while capable of freely changing the position and orientation of the tool 11, i.e. the position and orientation of the first end 11a1 of the tool (drill) 11. The first end 11a1 of the tool (drill) 11 will be also referred to as a working point WP of the tool 11, which serves as a specified point of the tool 11. For example, the tool support arm 12 includes a force sensor 13, a coupler 14, first to sixth links 15 to 20, unillustrated joints, a joint 21, actuators 22 to 27, and position sensors 28 to 33. For example, the tool support arm 12, the coupler 14, and the first to sixth links 15 to 20 serve as, for example, a support for supporting the tool 11 while the position and the orientation of the working point WP of tool 11 are changeable.

The coupler 14 has a substantially circular plate-like shape and opposing first and second major circular surfaces. The second end of the rigid support RS is coupled to the first major circular surface of the coupler 14.

The force sensor 13 is for example designed as a six-axis sensor device capable of measuring three-dimensional turning force and three-dimensional translational force of an object. The force sensor 13 has a substantially circular plate-like shape and opposing first and second major circular surfaces. The second major circular surface of the coupler 14 is mounted on the first major circular surface of the force sensor 13.

When using the tool movement device 10, a user, such as a doctor, grasps a part of the tool 11 and applies force to the tool 11. This force application aims to move the working point WP of the tool 11 to a desired position and a desired orientation according to deformation of the tool support arm 12, i.e. change of the posture of the tool support arm 12 via the joints. While the force is applied to the tool 11 so that force is applied to the coupler 14, the force sensor 13 measures the magnitude and orientation of the force being applied to the coupler 14.

In particular, the force sensor 13 is designed to measure force being applied to the tool 11, i.e. the coupler 14, by a user toward a target position, such as a predetermined point of a workpiece 40, for the working point WP of the tool 11 as a positive value proportional to the magnitude of the applied force. The force sensor 13 is also designed to measure reaction force being applied to the tool 11 from an object, such as the workpiece 40, as a negative value proportional to the magnitude of the applied reaction force; the reaction force is oriented to move the tool 11 away from the object, such as the workpiece 40.

The first to sixth links 15 to 20 are rigid members.

The first link 15 has a substantially circular plate-like shape, and first and second ends opposite to each other in an axial direction thereof. The first end of the first link 15 is directly joined to the second major circular surface of the force sensor 13.

The second end of the first link 15 is joined to the second link 16 via an unillustrated first joint while the first link 15 is rotatable about the axial direction thereof based on turning of the unillustrated first joint (see the two-dot chain line L1 in FIG. 2). Note that rotation of the first link 15 represents turning of the first link 15 with the position of its center of gravity being unchanged. That is, the tool 11, the force sensor 13, and the first link 15 are integrally rotatable about the axial direction of the first link 15 (see the two-dot chain line L1 in FIG. 2).

The second link 16 has a substantially circular plate-like shape, and first and second ends opposite to each other in an axial direction thereof. A portion of the circumferential side surface of the second link 16 is joined to the second end of the first link 15 via the unillustrated first joint set forth above. The second link 16 is joined to the third link 17 via an unillustrated second joint located perpendicular to the axial direction of the first link 15. The tool 11, the force sensor 13, and the first and second links 15 and 16 are integrally swingable about the axial direction of the second link 16 based on turning of the unillustrated second joint (see the two-dot chain line L2 in FIG. 2).

The third link 17 has a substantially pillar shape with a predetermined length, first forked ends, and a second end opposite to the first forked ends in a length direction thereof. The first forked ends of the third link 17 are joined to the second end of the second link 16 via the unillustrated second joint set forth above while the second link 16 is swingable based on rotation of the unillustrated second joint set forth above.

The second end of the third link 17 is joined to the fourth link 18 via an unillustrated third joint located perpendicular to the unillustrated second joint. The tool 11, the force sensor 13, and the first to third links 15 to 17 are integrally rotatable about the unillustrated third joint based on rotation of the unillustrated third joint (see the two-dot chain line L3 in FIG. 2).

The fourth link 18 has a substantially pillar shape with a predetermined length, and first and second ends opposite to each other in a length direction thereof. The first end of the fourth link 18 is joined to the second end of the third link 16 via the unillustrated third joint set forth above. The second end of the fourth link 18 is joined to the fifth link 19 via an unillustrated fourth joint. The tool 11, the force sensor 13, and the first to fourth links 15 to 18 are integrally swingable about the unillustrated fourth joint based on rotation of the unillustrated forth joint (see the two-dot chain line L4 in FIG. 2).

The fifth link 19 has a substantially pillar shape with a predetermined length, and first and second ends opposite to each other in a length direction thereof. The first end of the fifth link 19 has forked end portions, and the forked end portions are joined to the second end of the fourth link 18 via the unillustrated fourth joint set forth above. The second end of the fifth link 19 is joined to the sixth link 20 via a fifth joint 21 located substantially perpendicular to the length direction of the fifth link 19. The tool 11, the force sensor 13, and the first to fifth links 15 to 19 are integrally swingable about the fifth joint 21 based on rotation of the fifth joint 21 (see the two-dot chain line L5 in FIG. 2).

The sixth link 20 has a substantially pillar shape with a predetermined length, and first and second ends opposite to each other in a length direction thereof. The first end of the sixth link 20 has forked end portions, and the forked end portions are joined to the second end of the fifth link 19 via the fifth joint 21 set forth above. The second end of the sixth link 20 is joined to a cylindrical base 22 via an unillustrated sixth joint. The tool 11, the force sensor 13, and the first to sixth links 15 to 20 are integrally rotatable about the axial direction of the base 22 based on rotation of the unillustrated sixth joint (see the two-dot chain line L6 in FIG. 2).

The base 22 is located facing upwardly on a floor F of an operating room, which serves as, for example, a reference plane for the tool movement device 10, to support the tool support arm 12.

The actuator 22 and the position sensor 28 are provided for the first joint, and the actuator 23 and the position sensor 29 are provided for the second joint. The actuator 24 and the position sensor 30 are provided for the third joint, and the actuator 25 and the position sensor 31 are provided for the fourth joint. The actuator 26 and the position sensor 32 are provided for the fifth joint, and the actuator 27 and the position sensor 33 are provided for the sixth joint.

For example, each of the actuators 22 to 27 includes a motor. The actuator 22 is capable of rotating the first joint to thereby rotate the assembly of the elements 11, 13, and 15 about the first joint relative to the second link 16. The actuator 23 is capable of rotating the second joint to thereby swing the assembly of the elements 11, 13, 15, and 16 about the second joint relative to the third link 17.

The actuator 24 is capable of rotating the third joint to thereby rotate the assembly of the elements 11, 13, and 15 to 17 about the third joint relative to the fourth link 18. The actuator 25 is capable of rotating the fourth joint to thereby swing the assembly of the elements 11, 13, and 15 to 18 about the fourth joint relative to the fifth link 19.

The actuator 26 is capable of rotating the fifth joint to thereby swing the assembly of the elements 11, 13, and 15 to 19 about the fifth joint 21 relative to the sixth link 20. The actuator 27 is capable of rotating the sixth joint to thereby rotate the assembly of the elements 11, 13, and 15 to 20 about the sixth joint relative to the base 22.

Each of the position sensors 28 to 33 includes an encoder. The position sensor 28 measures the angular position or rotation quantity of the first joint caused by the actuator 22, and the position sensor 29 measures the angular position or rotation quantity of the second joint caused by the actuator 23. The position sensor 30 measures the angular position or rotation quantity of the third joint caused by the actuator 24, and the position sensor 31 measures the angular position or rotation quantity of the fourth joint caused by the actuator 25. The position sensor 32 measures the angular position or rotation quantity of the fifth joint 21 caused by the actuator 26, and the position sensor 33 measures the angular position or rotation quantity of the sixth joint caused by the actuator 27.

As described above, the tool support arm 12 includes the three joints, i.e. the first joint, the third joint, and the sixth joint, each of which is capable of rotating a corresponding assembly of links and the like. The tool support arm 12 also includes the three joints, i.e. the second joint, the fourth joint, and the fifth joint, each of which is capable of swinging a corresponding assembly of links and the like. The third joint enables a plane on which the second joint swings the corresponding assembly of links together therewith to be non-parallel to a plane on which the fourth joint swings the corresponding assembly of links together therewith. That is, the tool support arm 12 enables the position and/or orientation of the tool 11, i.e. the working point WP of the tool 11, to be changeable according to the rotation of at least one of the first to sixth joints.

The controller 70 is, for example, designed as a known microcomputer circuit including, for example, a CPU, a ROM, and a RAM. The controller 70 is communicably connected to the force sensor 13, the actuators 22 to 27, and the position sensors 28 to 33.

The controller 70 receives, from each of the position sensors 28 to 33, the angular position or rotation quantity of the corresponding joint measured thereby. Then, the controller 70 calculates the current posture of the tool support arm 12, i.e. how the tool support arm 12 is deformed. Based on the calculated posture of the tool support arm 12, the controller 70 calculates the position and orientation of the working point WP of the tool 11.

The controller 70 is also programmed to select, i.e. switch, its operation mode between the following predetermined first to fourth modes, i.e. the free mode, drill mode, reaction-force correction mode, and pullback mode according to, for example, the amount and/or orientation of force being applied to the tool 11 and/or the position of the working point WP of the tool 11.

For example, as illustrated in FIG. 2, a three-dimensional device-based coordinate system 34 is previously defined in the operating room in which the tool movement device 10 is installed. The device-based coordinate system 34 is defined in, for example, a circular portion of the floor F on which the base 22 is mounted. For example, the device-based coordinate system 34 includes an origin O1 corresponding to the center of the circular portion of the floor F on which the base 22 is mounted. The device-based coordinate system 34 includes a first axis Z1 corresponding to, for example, the axial direction of the base 22 extending from the origin O1. The device-based coordinate system 34 also includes second and third axes X1 and Y1 extending from the origin O1 to be perpendicular to the first axis Z1 to the respective predetermined directions (see FIG. 2).

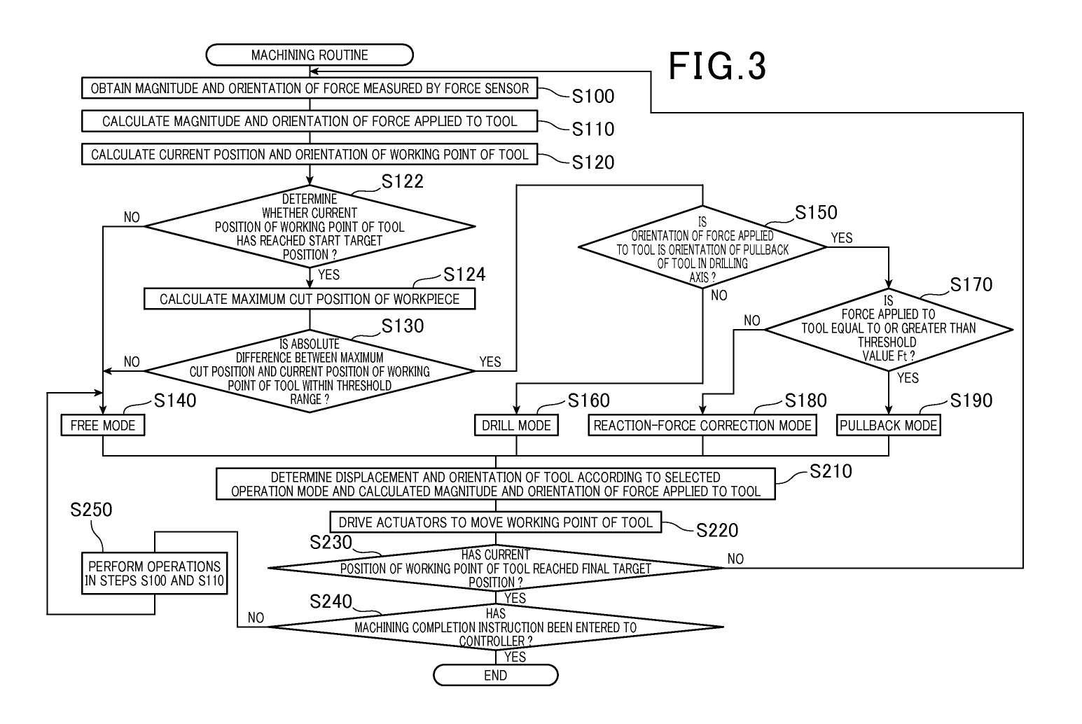

The input unit 72 is communicably connected to the controller 70. The input unit 72 allows a user or an assistant to enter a value of a target machining parameter representing a target amount of machining, i.e. a target amount of drilling, relative to a start target position on the workpiece 40. In particular, the target machining parameter of the exemplary embodiment can include a target depth of the machining, i.e. the drilling, relative to the target start position. The input unit 72 also permits a user or assistant to enter a machining start instruction to the controller 70 for starting a machining routine described later together with or after the entrance of the value of the target machining parameter. The input unit 72 further permits a user or assistant to enter a machining completion instruction for terminating the machining routine to the controller 70. The controller 70 performs the following machining routine (see FIG. 3) according to, for example, force applied to the tool 11 in response to the machining start instruction input thereto from the input unit 72. For example, the machining routine is a routine for making a hole at a missing tool portion of the jawbone in the mouth of a patient with the tool 11, i.e. the drill 11, for dental implant treatment.

The following describes the machining routine carried out by the controller 70 with reference to the flowchart of FIG. 3. The following uses the term “drill” as the tool 11 to describe the machining routine more understandable.

When entering the machining start instruction to the controller 70, a user, such as a doctor, or an assistant moves the drill 11 toward the workpiece 40.

When starting the machining routine in response to the machining start instruction, the controller 70 obtains the magnitude and orientation of force measured by the force sensor 13 in step S100.

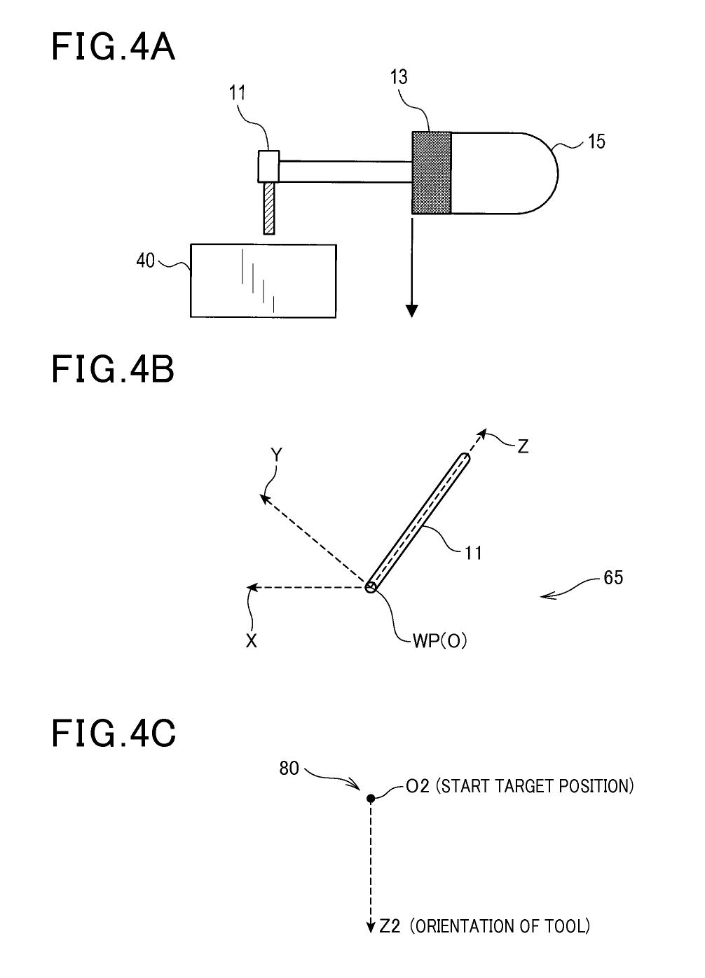

Note that the force measured by the force sensor 13 includes force applied by a user or an assistant to the drill 11 (see FIG. 4A) and reaction force generated upon abutment of the drill 11 onto the workpiece 40. In other words, the force measured by the force sensor 13 represents the resultant force obtained by vectorially synthesizing the force applied by a user or an assistant to the drill 11 and the reaction force generated upon abutment of the drill 11 onto the workpiece 40. Thus, the force measured by the force sensor 13 is basically comprised of the force applied by a user or an assistant to the drill 11 while the drill 11 is separated from the workpiece 40.

The force measured by the force sensor 13 is represented as a three-dimensional vector in a predetermined sensor-based coordinate system defined in the first major circular surface on which the coupler 14 is mounted. The sensor-based coordinate system follows change of the position of the force sensor 13. The sensor-based coordinate system has a first coordinate axis corresponding to, for example, the center axis of the first major circular surface of the force sensor 13, and the other second and third coordinate axes are defined to be perpendicular to the first coordinate axis.

Next, the controller 70 calculates the magnitude and orientation of force applied to the drill 11 in a tool-based coordinate system 65 defined in the drill 11 in step S110 (see FIG. 4B). The tool-based coordinate system 65 follows change of the position of the drill 11. The tool-based coordinate system 65, which is, for example, a three-dimensional coordinate system, has an origin O corresponding to the working point WP of the drill 11, i.e. the first end 11a1 of the drill 11, and a first axis Z corresponding to, for example, the axial direction of the drill 11. The tool-based coordinate system 65 also has the other second and third axes X and Y defined to be perpendicular to the first coordinate axis and passing through the origin O.

Specifically, in step S110, the controller 70 calculates the magnitude and orientation of the force applied to the drill 11 according to the magnitude and orientation of the force obtained in step S100; the force obtained in step S100 represents force applied to the coupler 14 between the drill 11 and the force sensor 13.

Subsequently, the controller 70 calculates the current position and orientation of the working point WP of the drill 11 according to the current angular position or rotation quantity of each joint of the tool support arm 12 measured by the corresponding position sensor in step S120.

Then, the controller 70 determines whether the drill 11 is subject to reaction force from the workpiece 40 according to the magnitude and orientation of force measured by the force sensor 13 in step S122. This determination means to determine whether the current position of the working point WP of the drill 11 has reached the start target position of the workpiece 40, in other words, the working point WP of the tool 11 has abutted onto the start target position of the workpiece 40 in step S122. Note that the affirmative determination in step S122 includes a case where the current position of the working point WP of the drill 11 has entered into the workpiece 40 to make a hole after abutment of the start target position of the workpiece 40.

Note that the controller 70 can determine whether the current position of the working point WP of the drill 11 has reached the start target position of the workpiece 40 according to information entered by, for example, an assistant from the input unit 72. The start target position of the workpiece 40 can have been specified based on images, for example, X-ray computed tomography (CT) images, and the controller 70 can determine whether the current position of the working point WP of the drill 11 has reached the specified start target position of the workpiece 40. The controller 70 can determine whether the current position of the working point WP of the drill 11 has reached the start target position of the workpiece 40 according to images of the drill 11 and its surrounding area picked up by a camera.

Upon determining that the drill 11 is not subject to reaction force from the workpiece 40, i.e. the current position of the working point WP of the tool 11 has not reached the start target position of the workpiece 40 (NO in step S122), the controller 70 sets its operation mode to the free mode in step S140.

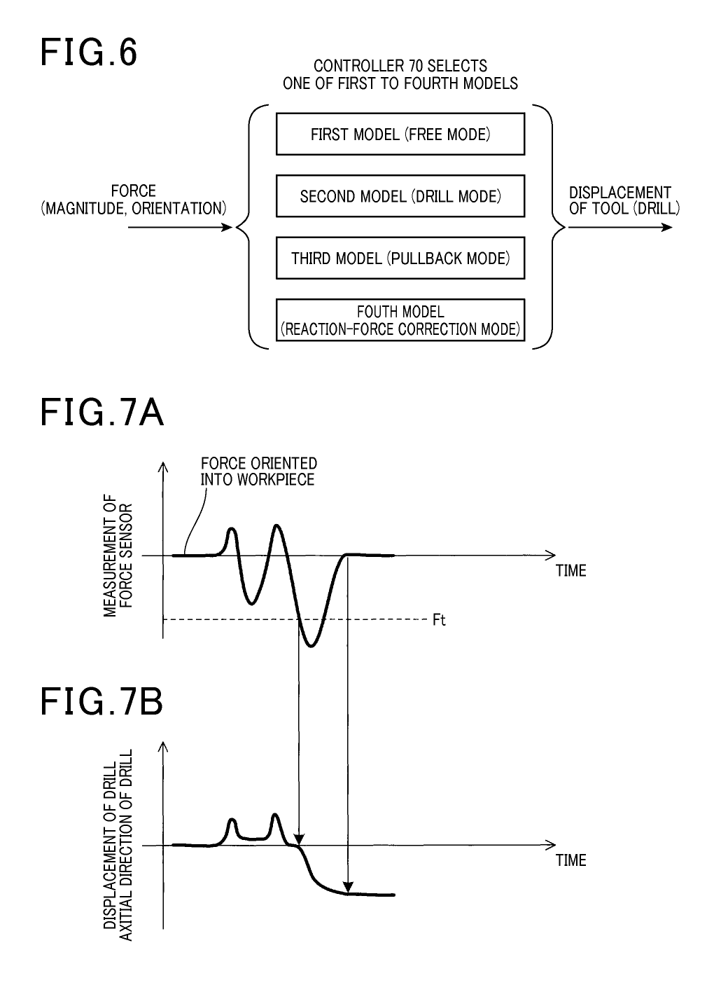

For example, the first embodiment previously prepares the first to fourth models for the respective free mode, drill mode, reaction-force correction mode, and pullback mode (see FIG. 6). Each of the first to fourth modes has a data-table format, a mathematical expression format, and/or a program format, and is stored beforehand in, for example, the ROM or RAM of the controller 70.

Each of the first to fourth models represents a relationship between the magnitude and orientation of force applied to the drill 11 and the displacement and orientation of the drill 11 based on change of the posture of the tool support arm 12, i.e. the amount of drive of each of the actuators 22 to 27.

Specifically, in step S140, the controller 70 selects the first model for the free mode, and refers to the first model using the calculated magnitude and orientation of force applied to the drill 11 (see step S110).

Then, the controller 70 determines, based on the selected operation mode, the displacement and orientation of the drill 11, i.e. the amount of drive of each of the actuators 22 to 27, which match with the calculated magnitude and orientation of force applied to the drill 11 in step S210.

In particular, the first model for the free mode is previously determined such that the orientation of the displacement of the drill 11 matches with the orientation of the force applied to the drill 11. In other words, under the controller 70 operating in the free mode, a user applies force to a predetermined orientation, which enables the drill 11 to move to the same orientation.

Specifically, in step S210, the controller 70 determines, based on the selected operation mode, the amount of drive of each of the actuators 22 to 27, which match with the calculated magnitude and orientation of force applied to the drill 11. In step S220, the controller 70 focuses on the tool-based coordinate system 65. Then, in step S220, the controller 70 drives each of the actuators 22 to 27 according to the amount of drive of the corresponding one of the actuators 22 to 27 determined in step S210. This moves the working point WP of the drill 11 according to the oriented displacement determined in step S210.

Following the operation in step S220, the controller 70 determines whether the current position of the working point WP of the drill 11 after the displacement in step S220 has reached a final target position, i.e. a final target depth, in step S230. Because the determination in step S122 is negative, i.e. the working point WP of the drill 11 has not reached the start target position of the workpiece 40, the determination in step S230 is negative. Then, the controller 70 returns to step S100, and performs the operations in steps S100 to S122.

Until it is determined that the drill 11 is subject to reaction force from the workpiece 40, the determination in step S122 is maintained negative, so that the operations in step S100 to S122, S140, S210 to S230 are repeated.

On the other hand, if it is determined that the drill 11 is subject to reaction force from the workpiece 40 (YES in step S122), the controller 70 calculates a maximum cut position of the workpiece 40; the maximum cut position of the workpiece 40 represents a position where the working point WP of the drill 11 has cut the workpiece 40 so as to reach in the workpiece 40 since the start of the machining routine in step S124.

For example, as illustrated in FIG. 4C, a one-dimensional drilling coordinate system 80 is previously defined. The drilling coordinate system 80 includes an origin O2 corresponding to the start target position on the workpiece 40. The drilling coordinate system 80 includes a drilling axis Z2 corresponding to the axial direction of the drill 11, in other words, the orientation of the working point of the drill 11, which represents the orientation of the drilling of the drill 11. That is, the positive orientation of the drilling axis Z2 corresponds to the orientation of the drilling of the drill 11.

That is, the maximum cut position is represented as a maximum Z coordinate in the axis Z2 of the drilling coordinate system 80.

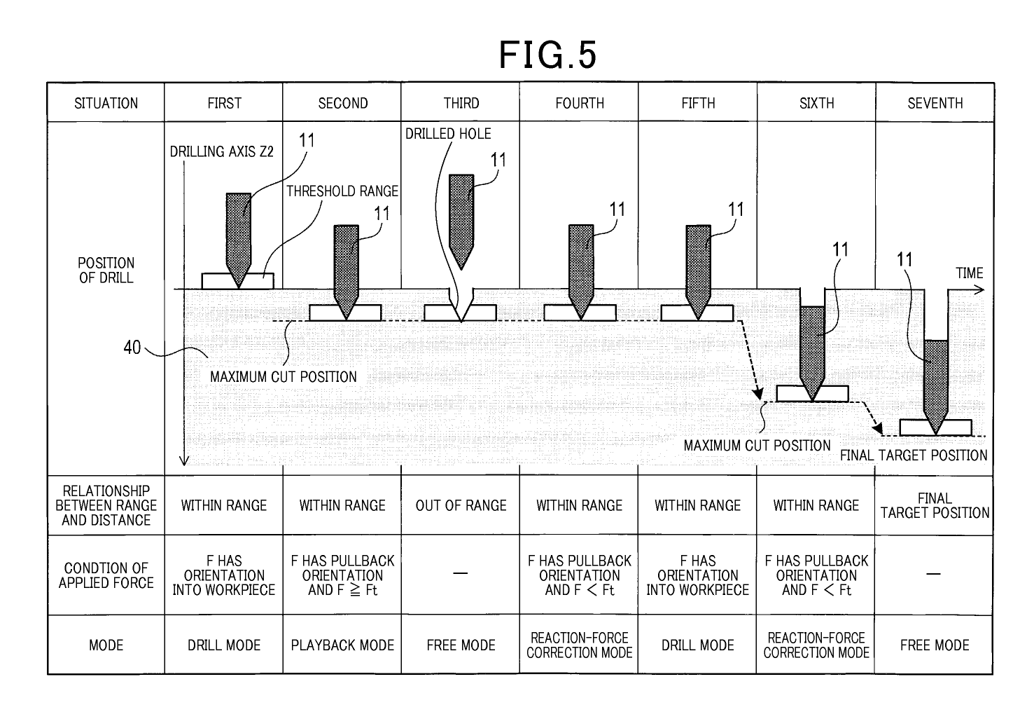

In step S124, when the position of the working point WP of the drill 11 is located at the start target position, so that drilling has not been carried out, the controller 70 calculates zero as the maximum cut position (see the first situation in FIG. 5). Note that the controller 70 repeatedly stores the calculated maximum cut position in, for example, the RAM thereof to update it each time the controller 70 newly calculates the maximum cut position in step S124.

Subsequently, the controller 70 calculates the absolute difference, i.e. the distance, between the current position of the working point WP of the drill 11 and the maximum cut position in the drilling direction Z2, and determines whether the difference is within a predetermined threshold range in step S130. The predetermined threshold range has a predetermined range of distance with respect to the maximum cut position in the drilling axis Z2.

Referring to FIG. 5, the predetermined threshold range has, for example, a rectangular parallelepiped shape that has a base rectangular surface including the current maximum cut position and being perpendicular to the drilling axis Z2, and has a predetermined height, i.e. depth, in the drilling axis Z2. In particular, the height of the rectangular-parallelepiped threshold range is previously determined based on reaction force applied to the drill 11 from the workpiece 40 to the negative direction of the drilling axis Z2. The negative direction of the drilling axis Z2 represents the direction of pullback of the drill 11 in the drilling axis Z2.

That is, the threshold range represents a range in the workpiece 40 where the drilling, i.e. the machining, of the drill 11 has been completed in the drilling axis Z2.

For example, the height of the threshold range in the drilling axis Z2 is set to several millimeters (mm) with respect to the maximum cut position.

Upon determining that the difference is out of the predetermined threshold range (NO in step S130), the controller 70 sets its operation mode to the free mode in step S140, and performs the operations in steps S210 to S230 set forth above.

In particular, let us consider the case where the controller 70 performs the determination in step S230 after the determination in step S122 is affirmative, i.e. the working point WP of the drill 11 has reached the start target position of the workpiece 40. In this case, in step S230, the controller 70 determines the final target position, i.e. the final target depth, according to the target amount of drilling or the target depth itself entered from the input unit 72, and the start target position determined in step S122. Then, the controller 70 determines whether the current position of the working point WP of the drill 11 after displacement in step S220 has reached the final target position, i.e. the final target depth, in step S230.

Upon determining that the current position of the working point WP of the drill 11 after displacement in step S220 has not reached the final target position (NO in step S230), the controller 70 returns to step S100, and performs the operations in steps S100 to S130.

Otherwise, upon determining that the difference is within the threshold range (YES in step S130), the controller 70 determines whether the orientation of the force applied to the drill 11 is the orientation of the pullback of the drill 11 in the drilling axis Z2 in step S150.

Upon determining that the orientation of the force applied to the drill 11 is not the orientation of the pullback of the drill 11 in the drilling axis Z2 (NO in step S150), the controller 70 sets its operation mode to the drill mode in step S160.

Specifically, in step S160, the controller 70 selects the second model for the drill mode, and refers to the second model using the calculated magnitude and orientation of force applied in the drill 11 (see step S110).

In particular, the second model for the drill mode is previously determined such that the orientation of the displacement of the drill 11 matches with the orientation of the force applied to the drill 11. In other words, under the controller 70 operating in the drill mode, a user applies force to a predetermined orientation, which enables the drill 11 to move to the same orientation.

Otherwise, upon determining that the orientation of the force applied to the drill 11 is the orientation of the pullback of the drill 11 in the drilling axis Z2 (YES in step S150), the machining routine proceeds to step S170.

In step S170, the controller 70 determines whether the magnitude of the force applied to the drill 11 is equal to or greater than a predetermined threshold value Ft. The predetermined threshold value Ft is set to be greater than the magnitude of reaction force applied to the drill 11 from the workpiece 40 upon user's careful abutment of the drill 11 onto the workpiece 40. For example, the threshold Ft is set to be smaller than the magnitude of reaction force applied to the drill 11 from the workpiece 40 upon user's very hasty abutment of the drill 11 onto the workpiece 40. Preferably, the threshold value Ft can be determined by experiments.

Upon determining that the magnitude of the force applied to the drill 11 is smaller than predetermined threshold value Ft (NO in step S170), the controller 70 sets its operation mode to the reaction-force correction mode in step S180.

Specifically, in step S180, the controller 70 selects the third model for the reaction-force correction mode, and refers to the third model using the calculated magnitude and orientation of force applied in the drill 11 (see step S110).

In particular, the third model for the reaction-force correction mode is previously determined such that the orientation of the displacement of the drill 11 is opposite to the orientation of the force applied to the drill 11. In other words, the controller 70 operating in the reaction-force correction mode makes displacement the drill 11 to abut onto the workpiece 40.

Otherwise, upon determining that the magnitude of the force applied to the drill 11 is equal to or greater than predetermined threshold value Ft (YES in step S170), the controller 70 sets its operation mode to the pullback mode in step S190.

Specifically, in step S190, the controller 70 selects the fourth model for the pullback mode, and refers to the fourth model using the calculated magnitude and orientation of force applied in the drill 11 (see step S110).

In particular, the fourth model for the pullback mode is previously determined such that the orientation of the displacement of the drill 11 matches with the orientation of the force applied to the drill 11. In other words, the controller 70 operating in the pullback mode enables the drill 11 to move to the orientation of the force applied to the drill 11.

After selecting the operation mode of the controller 70 from one of the free mode, the drill mode, the reaction-force correction mode, and the pullback mode in one of the steps S140, S160, S180, and S190, the machining routine proceeds to step S210.

The structure and/or function of the controller 70 for performing the operations in steps S130 to S190 serve as, for example, a determiner. The determiner is, for example, capable of determining, upon the force being applied to the tool 11, a target orientation of the working point WP of the tool 11 according to the magnitude and the orientation of the force measured by the force sensor 13. The force applied to the tool 11 has an orientation to separate the tool 11 from the workpiece 40.

In step S210, the controller 70 determines the displacement and orientation, i.e. a target orientation, of the drill 11, i.e. the amount of drive of each of the actuators 22 to 27 according to the selected operation mode and the calculated magnitude and orientation of the force applied to the drill 11.

In step S220, the controller 70 focuses on the tool-based coordinate system 65. Then, in step S220, the controller 70 drives each of the actuators 22 to 27 according to the amount of drive of the corresponding one of the actuators 22 to 27 determined in step S210. This moves the working point WP of the drill 11 according to the oriented displacement determined in step S210. In particular, the controller 70 operating in the drill mode causes the working point WP of the drill 11 to move while cutting, i.e. drilling, a hole in the workpiece 40.

For example, the structure and/or function of the controller 70 for performing the operations in steps S210 and S220 serve as, for example, a controller capable of, for example, controlling the actuators 22 to 27 to move the tool 11 according to the determined target orientation.

Note that the controller 70 can move the working point WP of the drill 11 in the drill mode slower than in the free mode to reduce reaction force applied to the drill 11 that is moving to making a hole in the workpiece 40. In addition, the controller 70 can move the working point WP of the drill 11 in the pullback mode faster than in the free mode.

Following the operation in step S220, the controller 70 determines whether the current position of the working point WP of the drill 11 after the displacement in step S220 has reached the final target position, i.e. the final target depth, in step S230.

If it is determined that the working point WP of the drill 11 has not reached the final target position (NO in step S230), the controller 70 returns to step S100, and performs the operations in steps S100 to S230 set forth above.

Otherwise, upon determining that the working point WP of the drill 11 has reached the final target position (YES in step S230), the controller 70 determines whether the machining completion instruction has been entered thereto from the input unit 72 in step S240.

Upon determining that the machining completion instruction has not been entered to the controller 70 from the input unit 72 (NO in step S240), the machining routine proceeds to step S250.

In step S250, the controller 70 performs the operations in steps S100 and S110 to calculate the magnitude and orientation of the force applied to the drill 11. Then, the controller 70 shifts or maintains its operation mode to the free mode (see step S140), and performs the operations in step S210 to S250 until the determination in step S240 is affirmative. That is, upon determining that the machining completion instruction has been entered thereto from the input unit 72 (YES in step S240), the controller 70 terminates the machining routine.

Next, the following describes how the drill 11 moves under control of the controller 70 for machining, i.e. drilling the workpiece 40 with reference to FIG. 5.

A user applies force to the drill 11 to move the working point WP of the drill 11 toward the start target position on the workpiece 40. At that time, because the working point WP of the drill 11 has not reached the start target position of the workpiece 40, the determination of step S122 is negative. Thus, the controller 70 is operating in the free mode (see step S140), so that the working point WP of the drill 11 moves freely to the orientation of the user's force applied to the drill 11. This results in the working point WP of the drill 11 abutting onto the start target position on the workpiece 40.

Upon the working point WP of the drill 11 abutting onto the start target point of the workpiece 40, the maximum cut position is calculated as zero in step S124, so that the difference between the current position of the working point WP of the drill 11 and the maximum cut position is within the predetermined threshold range. Thus, the determination of step S130 is affirmative. In addition, the orientation of the force applied to the drill 11 is the orientation into the workpiece 40 (NO in step S150). Thus, the controller 70 is operating in the drill mode (see step S160 and the first situation in FIG. 5), so that the drill 11 starts to drill the workpiece 40 from the start target point into the workpiece 40 in the drilling direction Z2 according to the force applied to the drill 11. Note that FIG. 5 expresses force applied to the drill 11 as reference character F.

During the drilling, let us consider a case where

(1) The maximum cut position is within the predetermined threshold range (YES in step S130)

(2) The orientation of the force applied to the drill 11 is the orientation of the pullback of the drill 11 in the drilling axis Z2 (YES in step S150)

(3) The magnitude of the force including the reaction force applied to the drill 11 from the workpiece 40 is equal to or greater than the threshold value Ft (YES in step S160).

This may occur due to, for example, application of a user's force to the drill 11 to pull back the drill 11 in addition to the reaction force.

In this case, the controller 70 is operating in the pullback mode (see step S190), so that the drill 11 is pulled back toward the negative direction of the drilling axis Z2 from the drilled hole according to the force applied to the drill 11 (see the second situation in FIG. 5).

If the force applied to the drill 11 moves the working point WP of the drill 11 out of the threshold range (NO in step S130), the controller 70 shifts its operation mode from the pullback mode to the free mode (see step S140). Thus, a user enables retry of application of force to the drill 11 to move the working point WP of the drill 11 freely into the drilled hole in order to continuously drill the workpiece 40 (see the third situation in FIG. 5).

At that time, when the working point WP of the drill 11 abuts onto the maximum cut position in the drilled hole, let us consider a case where

(1) The maximum cut position is within the predetermined threshold range (YES in step S130)

(2) The orientation of the force applied to the drill 11 is the orientation of the pullback of the drill 11 in the drilling axis Z2 (YES in step S150)

(3) The magnitude of the force, i.e. the reaction force, applied to the drill 11 from the workpiece 40 is smaller than the threshold value Ft (NO in step S160).

In this case, the controller 70 is operating in the reaction-force correction mode (see step S180), so that the drill 11 is entering into the workpiece 40 to drill it against the reaction force applied to the drill 11 from the workpiece 40 (see the fourth situation in FIG. 5).

Thereafter, the progress of the drilling into the workpiece 40 enables the reaction force to be relatively small. As a result, after the reaction-force correction mode, the controller 70 shifts its operation mode from the reaction-force control mode to the drill mode. This causes the drill 11 to continuously drill the workpiece 40 (see fifth situation in FIG. 5).

After the progress of the drilling, when the working point WP of the drill 11 gradually approaches the final target position, the user's force applied to the drill 11 gradually decreases. At that time, if the orientation of the force applied to the drill 11 is the orientation of the pullback of the drill 11 in the drilling axis Z2 (YES in step S150), and the magnitude of the force, i.e. the reaction force, applied to the drill 11 from the workpiece 40 is smaller than the threshold value Ft (NO in step S160), the controller 70 shifts its operation mode from the drill mode to the reaction-force correction mode. This enables the drill 11 to continuously drill the workpiece 40 against the reaction force applied to the drill 11 from the workpiece 40 (see the sixth situation in FIG. 5).

Thereafter, when the working point WP of the drill 11 has reached the final target position (YES in step S230), the controller 70 shifts its operation mode from the reaction-force correction mode to the free mode if it has not received the machining completion instruction from the input unit 72.

The reaction force in the free mode prevents the drill 11 from further drilling over the final target position into the workpiece 40. This therefore reduces over-drilling of the workpiece 40.

FIG. 7A schematically illustrates an example of how the measurement of the force sensor 13 changes over time, and FIG. 7B schematically illustrates an example of how the working point WP of the drill 11 moves in the axial direction of the drill 11

From time t1 to time t2, force applied to the drill 11 moves the drill 11 so as to abut onto the start target position on the workpiece 40. At the time t2, the difference between the current position of the working point WP of the drill 11 and the maximum cut position is within the predetermined threshold range. Thus, the drill 11 starts to drill the workpiece 40 from the start target point into the workpiece 40 in the drilling direction Z2 according to the force applied to the drill 11 while the controller 70 is operating in the drill mode (see the first situation in FIG. 5).

The progress of the drilling of the drill 11 into the workpiece results in the reaction force applied to the drill 11 being greater than the user's force applied thereto at time t3. At that time, the operation mode of the controller 70 shifts to the reaction force correction mode.

In the reaction-force control mode, even if the reaction force increases from the time t3 to time t4, the controller 70 operating in the reaction-force control mode enables the drill 11 to drill the workpiece 40 against the reaction force applied to the drill 11 from the workpiece 40 (see the fourth situation in FIG. 5).

From the time t4 to time t5, the reaction force gradually decreases so as to be zero. Then, the operation mode of the controller 70 shifts from the reaction force correction mode to the drill mode, so that the work point WP of the drill 11 further enters into the workpiece 40 while drilling it from the time t5 to time t6.

From the time t6 to t7, the operation mode of the controller 70 is set to the drill mode while the user's force applied to the drill 11 is equal to or greater than the reaction force applied thereto, and to the reaction-force control mode while the user's force applied to the drill 11 is smaller than the reaction force applied thereto set forth above. This enables the drill 11 to continuously drill the workpiece 40 (see the fifth and sixth situations in FIG. 5).

Note that, at the time t7, when the magnitude of the force applied to the drill 11 is equal to or greater than the threshold value Ft (YES in step S170), the operation mode of the controller 70 shifts to the pullback mode. This is based on, for example, application of a user's force to the drill 11 to pull back the drill 11 in addition to the reaction force. This causes the drill 11 to be pulled back toward the negative direction of the drilling axis Z2 (see FIG. 7B). Thereafter, the operation mode is set to the free mode.

The above machining apparatus 1 of the exemplary embodiment is configured to measure the magnitude and orientation of force applied to the tool 11 after abutment of the tool 11 onto the workpiece 40. Then, the machining apparatus 1 is configured to determine, according to the measured magnitude and orientation of the force applied to the tool 11, whether to drive the actuators 22 to 27 to

(1) Move the tool 11 in a first direction to push the tool 11 onto the workpiece 40 or

(2) Move the tool 11 in a second direction to move the tool 11 away from the workpiece 40.

This configuration therefore enables proper determination of whether to move the tool 11 in the second direction or in the first direction according to, for example, a user's intention and/or the magnitude of the reaction force applied to the tool 11 from the workpiece 40. This prevents the tool 11 from being pushed onto the workpiece 40 against a user's intention, and improves the flexibility of movement of the tool 11 for machining the workpiece 40.

The controller 70 of the machining apparatus 1 is configured to push the tool 11 onto the workpiece 40 to thereby machine it against the reaction force being applied to the tool 11 from the work piece 40. This configuration enables the tool 11 to continuously machine the workpiece 40 even if the reaction force is applied to the tool 11 from the workpiece 40. This reliably completes machining of the workpiece 40 with the tool 11 even if reaction force is applied from the workpiece 40 to the tool 11.

The controller 70 of the machining apparatus 1 calculates the maximum cut position that the working point WP of the drill 11 has cut the workpiece 40 to reach since the start of the machining routine in the drilling direction corresponding to the positive direction of the drilling axis Z2. The controller 70 repeatedly stores the calculated maximum cut position in, for example, the RAM thereof to update it each time the controller 70 newly calculates the maximum cut position. Then, the controller 70 determines whether the difference, i.e. the distance, between the current position of the working point WP of the tool 11 and the maximum cut position, and determines whether the difference is within the threshold range.

Upon determining that the difference is out of the threshold range, the controller 70 drives the actuators 22 to 27 to move the tool 11 away from the workpiece 40 upon the force being applied to the tool 11 in a direction to move the tool 11 away from the workpiece 40.

Specifically, the machining apparatus 1 drives the actuators 22 to 27 to move the tool 11 away from the workpiece 40 upon force, which has an orientation to separate the tool 11 from the workpiece 40, being applied to the tool 11 if the working point WP of the tool 11 is located out of the threshold range where the machining has been already completed. This is because the working point WP of the tool 11 need not be pushed onto the region of the workpiece 40 where the machining has been already completed. The above machining apparatus 1 therefore enables a smaller force to be applied to the tool 11 to easily separate the tool 11 from the workpiece 40 if the working point WP of the tool 11 is located out of the threshold range where the machining has been already completed.

The controller 70 of the machining apparatus 1 determines whether the working point WP of the tool 11 has reached the final target position as an example of a final target region. Upon determining that the working point WP of the tool 11 has reached the final target position, the controller 70 drives the actuators 22 to 27 to separate the tool 11 from the workpiece 40 according to force, which has an orientation to separate the tool 11 from the workpiece 40, being applied to the tool 11 independently of the magnitude of the applied force. This is because the working point WP of the tool 11 need not be pushed onto the workpiece 40 if the working point WP of the tool 11 has reached the final target position. The above machining apparatus 1 therefore enables smaller force applied to the tool 11 to easily separate the tool 11 from the workpiece 40 after completion of machining of the workpiece 40.

The controller 70 of the machining apparatus 1 is configured to determine whether force, which has an orientation to separate the tool 11 from the workpiece 40, applied to the tool 11 is equal to or greater than the threshold value Ft.

Upon determining that the force, which has an orientation to separate the tool 11 from the workpiece 40, applied to the tool 11 is equal to or greater than the threshold value Ft, the controller 70 drives the actuators 22 to 27 to separate the tool 11 from the workpiece 40 according to the force applied to the tool 11.

Otherwise, upon determining that the force, which has an orientation to separate the tool 11 from the workpiece 40, applied to the tool 11 is smaller than the threshold value Ft, the controller 70 drives the actuators 22 to 27 to push the tool 11 onto the workpiece 40 against the applied force to the tool 11.

This configuration of the machining apparatus 1 enables the tool 11 to separate from the workpiece 40 according to the relationship between the magnitude of the applied force, which is based on a user and/or reaction force of the workpiece 40, and the threshold value Ft. This therefore properly reflects a user's intention and/or the reaction force applied to the tool 11 from the workpiece 40 on control of movement of the tool 11.

The machining apparatus 1 uses a medical device as the tool 11, thus controlling movement of the working point WP of the medical device according to a user's intention and/or reaction force applied to the medical device from the workpiece 40.

In particular, the machining apparatus 1 uses, as the tool 11, a drill for cutting away part of at least one of a patient's tooth or bone as the workpiece 40. This therefore controls movement of the working point WP of the drill according to a user's intention and/or reaction force applied to the drill a1 device from the patient's tooth or bone.

The present disclosure is not limited to the aforementioned embodiment, and various modifications of the embodiment can be performed within the scope of the present disclosure.

The present disclosure can include various modifications, each of which includes at least the machining apparatus 1. For example, the present disclosure includes a system including as its one element of the disclosed machining apparatus 1, and a program product for causing a computer to serve as the machining apparatus 1, a method of machining a workpiece according to the above machining method carried out by the machining apparatus 1.

The machining apparatus 1 according to the exemplary embodiment of the present disclosure determines the orientation to move the tool 11 according to whether the magnitude of force applied to the tool 11 is equal to or greater than the threshold value Ft (see step S170). The machining apparatus 1 can control movement of the tool 11 according to the magnitude of force applied to the tool 11. For example, the machining apparatus 1 can maintain the tool 11 without movement upon determining that the magnitude of the applied force is smaller than the threshold Ft or another threshold. The machining apparatus 1 also can move the tool 11 to an orientation, which is the safest in all orientations, upon determining that the magnitude of the applied force is excessively greater than the threshold Ft or another threshold.

While the illustrative embodiment of the present disclosure has been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A machining apparatus comprising:
a tool, having a specified point, for machining a workpiece;
a support that supports the tool while a position and an orientation of the specified point of the tool are changeable;
an actuator that actuates the support to move the tool;
a sensor that measures a magnitude and an orientation of force upon the force being applied to the tool;
a determiner that determines, upon the force being applied to the tool, a target orientation of the specified point of the tool according to the magnitude and the orientation of the force measured by the sensor, the force applied to the tool having an orientation to separate the tool from the workpiece; and
a controller that controls the actuator to move the tool according to the determined target orientation.

2. The machining apparatus according to claim 1, wherein:
the determiner is configured to determine, upon the force being applied to the tool, the target orientation of the specified point of the tool according to the magnitude of the force measured by the sensor, the target orientation being one of a first orientation to push the tool onto the workpiece and a second orientation to separate the tool from the workpiece.

3. The machining apparatus according to claim 1, wherein the tool is configured to machine the workpiece by the specified point thereof while the specified point of the tool being moved into the workpiece, a direction into which the specified point of the tool is moved to machine the workpiece being defined as a machining direction,
the machining apparatus further comprising:
a storing unit that stores a maximum machined position of the workpiece, the maximum machined position of the workpiece representing a position where the specified point of the tool has machined the workpiece so as to reach in the workpiece; and
a threshold-range determiner that determines whether the position of the specified point of the tool is within a predetermined threshold range in the machining direction,
the threshold range having a predetermined distance with respect to the maximum machined position in the machining direction, and
the determiner is configured to determine, upon the force being applied to the tool, an orientation to separate the tool from the workpiece as the target orientation of the specified point of the tool independently of the magnitude of the applied force to the tool when it is determined that the position of the specified point of the tool is out of the predetermined threshold range in the machining direction.

4. The machining apparatus according to claim 2, wherein the tool is configured to machine the workpiece by the specified point while the specified point of the tool being moved into the workpiece, a direction into which the specified point of the tool is moved to machine the workpiece being defined as a machining direction,
the machining apparatus further comprising:
a storing unit that stores a maximum machined position of the workpiece, the maximum machined position of the workpiece representing a position where the specified point of the tool has machined the workpiece so as to reach in the workpiece; and
a threshold-range determiner that determines whether the position of the specified point of the tool is within a predetermined threshold range in the machining direction,
the threshold range having a predetermined distance with respect to the maximum machined position in the machining direction, and
the determiner is configured to determine, upon the force being applied to the tool, the second orientation to separate the tool from the workpiece as the target orientation of the specified point of the tool independently of the magnitude of the applied force to the tool when it is determined that the position of the specified point of the tool is out of the predetermined threshold range in the machining direction.

5. The machining apparatus according to claim 1, further comprising:
a final target-region determiner that determines whether the position of the specified point of the tool is within a predetermined final target region,
the determiner being configured to determine, upon the force being applied to the tool, an orientation to separate the tool from the workpiece as the target orientation of the specified point of the tool independently of the magnitude of the applied force to the tool when it is determined that the position of the specified point of the tool is within the predetermined final target range.

6. The machining apparatus according to claim 2, further comprising:
a final target-region determiner that determines whether the position of the specified point of the tool is within a predetermined final target region,
the determiner being configured to determine, upon the force being applied to the tool, the second orientation to separate the tool from the workpiece as the target orientation of the specified point of the tool independently of the magnitude of the applied force to the tool when it is determined that the position of the specified point of the tool is within the predetermined final target range.

7. The machining apparatus according to claim 1, wherein:
the determiner is configured to:
determine whether the magnitude of the force measured by the sensor is equal to or greater than a threshold value;
determine, according to the magnitude of the force measured by the sensor, a first orientation to push the tool onto the workpiece as the target orientation of the specified point of the tool when it is determined that the magnitude of the force measured by the sensor is smaller than the threshold value; and
determine, according to the magnitude of the force measured by the sensor, a second orientation to separate the tool from the workpiece as the target orientation of the specified point of the tool when it is determined that the magnitude of the force measured by the sensor is equal to or greater the threshold value.

8. The machining apparatus according to claim 1, wherein:
the force applied to the tool is resultant force resulting from vectorial synthesizing of pushing force applied by a user to push the tool onto the workpiece and reaction force applied to the tool from the workpiece; and
the determiner is configured to:
determine whether the magnitude of the resultant force measured by the sensor is equal to or greater than a threshold value;
determine, according to the magnitude of the resultant force measured by the sensor, a first orientation to push the tool onto the workpiece as the target orientation of the specified point of the tool against the resultant force when it is determined that the magnitude of the resultant force measured by the sensor is smaller than the threshold value; and
determine, according to the magnitude of the resultant force measured by the sensor, a second orientation to separate the tool from the workpiece as the target orientation of the specified point of the tool when it is determined that the magnitude of the resultant force measured by the sensor is equal to or greater the threshold value.

9. The machining apparatus according to claim 1, wherein the tool comprises a medical device.

10. The machining apparatus according to claim 1, wherein the tool comprises a drill for cutting away part of at least one of a tooth or a bone of a patient using the specified point of the drill.
